(19) United States
(12) Patent Application Publication
(10) Pub. No.: US 2025/0227574 A1
(43) Pub. Date: Jul. 10, 2025

(54) METHOD AND APPARATUS FOR HANDLING PRECONFIGURED MEASUREMENT GAPS DURING HANDOVER

(71) Applicant: SAMSUNG ELECTRONICS CO., LTD., Suwon-si, Gyeonggi-do (KR)

(72) Inventors: Aby Kanneath ABRAHAM, Bangalore (IN); Taeseop LEE, Suwon-si (KR); June HWANG, Suwon-si (KR)

(21) Appl. No.: 18/854,004

(22) PCT Filed: Apr. 5, 2023
(86) PCT No.: PCT/KR2023/004553

§ 371 Date: Oct. 3, 2024

(30) Foreign Application Priority Data
Apr. 5, 2022 (IN) 202241020471
Mar. 28, 2023 (IN) 202241020471

(51) Int. Cl. H04W 36/00; H04W 24/10; H04W 76/27

(52) U.S. Cl. CPC H04W 36/0088; H04W 24/10; H04W 76/27

(57) ABSTRACT

The disclosure relates to a 5G or 6G communication system for supporting a higher data transmission rate. Embodiments herein is to provide a method and User Equipment (UE) (110) for handling preconfigured measurement gaps during handover in a wireless network. The method includes performing. by the UE (110) in the wireless network, a handover from a first network node (130) to a second network node (120) in the wireless network. The method further includes deactivating. by the UE (110), one or more preconfigured measurement gaps without sending Uplink Medium Access Control Control Element (UL MAC CE). The method further includes detecting. by the UE (110), that the one or more preconfigured measurement gaps need to be activated or re-activated after the handover is completed. The method further includes activating or reactivating. by the UE (110), the one or more preconfigured measurement gaps by sending the UL MAC CE.

### TECHNICAL FIELD

The present invention relates to wireless communication, and more specifically to a method and user equipment for handling preconfigured measurement gaps during handover.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In wireless technologies such as a New Radio (NR) and a Long Term Evolution (LTE), a Radio Resource Control (RRC) connected User Equipment (UE) performs various measurements for a Radio Resource Management (RRM) purpose, positioning and others. However the RRC connected UE cannot measure other frequencies while simultaneously transmitting/receiving on a serving node. Thus measurement gaps are introduced to measure such frequencies while simultaneously transmitting/receiving on the serving node.

In conventional methods, the UE is configured with the measurement gaps and the measurement gaps once configured remains activate. Further the measurement gaps are activated or deactivated dynamically through a Radio Resource Control (RRC) signaling or a Layer2 Medium Access Control (MAC) signaling or based on some predefined actions for a type of gaps like pre-configured measurement gap. However during handover in the conventional methods the target node is not aware of status of the measurement gaps that is currently configured in the UE that causes the target node to consider the pre-configured gap that is activated in the UE as de-activated and vice-versa.

Thus, it is desired to address the above mentioned disadvantages or other shortcomings or at least provide a useful alternative to handle measurement gaps during the handover scenarios.

### DISCLOSURE OF INVENTION

### Technical Problem

The principal object of the embodiments herein is to provide a method and user equipment (UE) for handling preconfigured measurement gaps during handover. The method includes activating or reactivating one or more preconfigured measurement gaps by sending a Uplink Medium Access Control Control Element (UL MAC CE), where the one or more preconfigured measurement gaps is configured during the handover or before the handover. The proposed method ensures that the UE and network are in sync about an activation status of the one or more preconfigured measurement gap after handover.

Another object of the embodiments herein is to send the UL MAC CE to a second network node to re-activate the one or more preconfigured measurement gaps that was previously active before the handover when the one or more preconfigured measurement gaps is not modified.

Another object of the embodiments herein is to send the UL MAC CE to the second network node to activate a one or more new measurement gaps or modify the one or more preconfigured measurement gaps when the one or more pre-configured measurement gaps is modified.

### Solution to Problem

Accordingly the embodiment herein is to provide a method for handling pre-configured measurement gaps during handover in a wireless network. The method includes performing, by an User Equipment (UE) in the wireless network, a handover from a first network node to a second network node in the wireless network. The method further includes deactivating, by the UE, one or more preconfigured measurement gaps without sending Uplink Medium Access Control Control Element (UL MAC CE). The method further includes detecting, by the UE that the one or more pre-configured measurement gaps need to be activated or re-activated after the handover is completed. The method further includes activating or reactivating, by the UE, the one or more preconfigured measurement gaps by sending the UL MAC CE.

In an embodiment, the one or more preconfigured measurement gaps is configured during the handover or before the handover

In an embodiment, the method includes receiving, by the UE, a Downlink MAC Control Element (DL MAC CE) to activate or deactivate one or more preconfigured measurement gaps at a UE MAC layer. The method further includes informing, by the UE, a Radio Resource Control (RRC) and other upper layers, an activation or deactivation status of the one or more preconfigured measurement gaps by the UE MAC layer.

In an embodiment, the method includes determining, by the UE, whether the one or more preconfigured measurement gaps is modified during the handover. The method further includes determining, by the UE, whether the UE is required to stop performing measurements using the one or more pre-configured measurement gaps. The method further includes sending the UL MAC CE to the second network node to re-activate the one or more preconfigured measurement gaps that was previously active before the handover when the one or more preconfigured measurement gaps is not modified and the UE is not required to stop performing measurements using the one or more pre-configured measurement gaps. The method further includes sending the UL MAC CE to the second network node to activate at least one of a one or more new measurement gaps and modify the one or more preconfigured measurement gaps when the one or more pre-configured measurement gaps is modified and the UE is not required to stop performing measurements using the one or more pre-configured measurement gaps.

In an embodiment, the method includes receiving, by the UE, a RRC reconfiguration message from the first network node. The method further includes determining, by the UE, whether the RRC reconfiguration message comprises at least one of a gap activation status and reset gap activation status indication and a keep gap activation status indication. The method further includes deactivating all preconfigured measurement gaps when the RRC reconfiguration message comprises the reset gap activation status indication. The method further includes keeping the activated pre-configured measurement gaps remains active and deactivated preconfigured measurement gaps remain deactivated when the RRC reconfiguration message comprises the keep gap activation status indication or when the UE does not receives the gap activation status from the first network node.

In an embodiment, the method includes receiving, by the UE, the RRC reconfiguration message from the first network node including a second network node RRC Reconfiguration message containing a ReconfigurationwithSync that is received from the second network node. The method further includes executing, by the UE, a ReconfigurationwithSync procedure for handover. The method further includes receiving, by the UE, a conditional reconfiguration message from the first network node; determining, by the UE, whether the conditions in the conditional reconfiguration message are fulfilled. The method further includes executing, by the UE, a ReconfigurationwithSync procedure for handover when the conditions for the execution in the conditional reconfiguration message are fulfilled

Accordingly the embodiment herein is to provide a method for handling preconfigured measurement gaps during handover in a wireless network. The method further includes receiving, by a second network node in the wireless network, an activation status of one or more preconfigured measurement gaps from a first network node in a handover request message. The method further includes transmitting, by the second network node, the activation status of the one or more preconfigured measurement gaps from a Centralized Unit (CU) of the second network node to a Distributed Unit (DU) of the second network node. The method further includes setting the activation status by the DU of the second network node of the one or more pre-configured measurement gaps based on the received activation status from the CU of the second network node. The method further includes transmitting, by the second network node, a Downlink MAC Control Element (DL MAC CE) to activate or deactivate the one or more preconfigured measurement gaps. The method further includes setting the activation status as deactivated by the DU of the second network node; and not transmitting the DL MAC CE to activate or deactivate the one or more preconfigured measurement gaps.

Accordingly the embodiment herein is to provide the UE for handling preconfigured measurement gaps during handover in the wireless network, comprises: a memory; a processor coupled to the memory; and a measurement gaps controller coupled to the memory and the processor. The measurement gaps controller is configured to perform the handover from the first network node to the second network node in the wireless network. The measurement gaps further controller is deactivate one or more preconfigured measurement gaps without sending UL MAC CE. The measurement gaps further controller is detect that the one or more preconfigured measurement gaps need to be activated or re-activated after the handover is completed. The measurement gaps further controller is activate or reactivate the one or more preconfigured measurement gaps by sending the UL MAC CE.

Accordingly the embodiment herein is to provide the second network node for handling preconfigured measurement gaps during handover in the wireless network, comprises: the memory; the processor coupled to the memory; and a measurement gaps manager coupled to the memory and the processor. The measurement gaps manager is configured to receive the activation status of one or more preconfigured measurement gaps from the first network node in the handover request message. The measurement gaps manager is further configured to transmit the activation status of the one or more preconfigured measurement gaps from the CU of the second network node to the DU of the second network node. The measurement gaps manager is further configured to set the activation status by the DU of the second network node of the one or more preconfigured measurement gaps based on the received activation status from the CU of the second network node; and transmitting, by the second network node, the DL MAC CE to activate or deactivate the one or more preconfigured measurement gaps. The measurement gaps manager is further configured to set the activation status as deactivated by the DU of the second network node; and not transmitting the DL MAC CE to activate or deactivate the one or more preconfigured measurement gaps. The UE uses the one or more preconfigured measurement gaps for performing measurements when the preconfigured measurement gap is activated and doesn't use the one or more preconfigured measurement gap when it is deactivated.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and apparatus for handling preconfigured measurement gaps during handover.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1A is a sequence diagram for measurement gaps activation and deactivation for positioning measurement gaps, according to the prior arts;

FIG. 1B is a block diagram of the system for handling preconfigured measurement gaps during a handover, according to the embodiments as disclosed herein;

FIG. 2 is a flow chart illustrating a method for handling the preconfigured measurement gaps during the handover by a User Equipment (UE), according to the embodiments as disclosed herein;

FIG. 3 is a flow chart illustrating a method for handling the preconfigured measurement gaps during the handover by a second network node, according to the embodiments as disclosed herein;

FIG. 4 illustrating a whole scenario of handling of the preconfigured measurement gaps during handover, according to the embodiments as disclosed herein;

FIG. 5 illustrating a scenario of handling a Downlink Medium Access Control Control Element (DL MAC CE) by the UE to activate or deactivate the preconfigured measurement gaps, according to the embodiments as disclosed herein;

FIG. 6 illustrating a scenario of handling the DL MAC CE by the second network node, according to the embodiments as disclosed herein;

FIG. 7 illustrating a scenario of handling the preconfigured measurement gaps by a first network node, according to the embodiments as disclosed herein; and

FIG. 8 illustrating a scenario of determining gap activation status in Radio Resource Control (RRC) message, according to the embodiments as disclosed herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one clement from another.

Accordingly the embodiment herein is to provide a method for handling pre-configured measurement gaps during handover in a wireless network. The method includes performing, by an User Equipment (UE) in the wireless network, a handover from a first network node to a second network node in the wireless network. The method further includes deactivating, by the UE, one or more preconfigured measurement gaps without sending Uplink Medium Access Control Control Element (UL MAC CE). The method further includes detecting, by the UE, that the one or more pre-configured measurement gaps need to be activated or re-activated after the handover is completed. The method further includes activating or reactivating, by the UE, the one or more preconfigured measurement gaps by sending the UL MAC CE.

Accordingly the embodiment herein is to provide a method for handling pre-configured measurement gaps during handover in a wireless network. The method further includes receiving, by a second network node in the wireless network, an activation status of one or more preconfigured measurement gaps from a first network node in a handover request message. The method further includes transmitting, by the second network node, the activation status of the one or more preconfigured measurement gaps from a Centralized Unit (CU) of the second network node to a Distributed Unit (DU) of the second network node. The method further includes setting the activation status by the DU of the second network node of the one or more pre-configured measurement gaps based on the received activation status from the CU of the second network node. The method further includes transmitting, by the second network node, a Downlink MAC Control Element (DL MAC CE) to activate or deactivate the one or more preconfigured measurement gaps. The method further includes setting the activation status as deactivated by the DU of the second network node; and not transmitting the DL MAC CE to activate or deactivate the one or more preconfigured measurement gaps.

Accordingly the embodiment herein is to provide the UE for handling preconfigured measurement gaps during handover in the wireless network, comprises: a memory; a processor coupled to the memory; and a measurement gaps controller coupled to the memory and the processor. The measurement gaps controller is configured to perform the handover from the first network node to the second network node in the wireless network. The measurement gaps further controller is deactivate one or more pre-configured measurement gaps without sending UL MAC CE. The measurement gaps further controller is detect that the one or more preconfigured measurement gaps need to be activated or re-activated after the handover is completed. The measurement gaps further controller is activate or reactivate the one or more preconfigured measurement gaps by sending the UL MAC CE.

Accordingly the embodiment herein is to provide the second network node for handling preconfigured measurement gaps during handover in the wireless network, comprises: the memory; the processor coupled to the memory; and a measurement gaps manager coupled to the memory and the processor. The measurement gaps manager is configured to receive the activation status of one or more preconfigured measurement gaps from the first network node in the handover request message. The measurement gaps manager is further configured to transmit the activation status of the one or more preconfigured measurement gaps from the CU of the second network node to the DU of the second network node. The measurement gaps manager is further configured to set the activation status by the DU of the second network node of the one or more preconfigured measurement gaps based on the received activation status from the CU of the second network node; and transmitting, by the second network node, the DL MAC CE to activate or deactivate the one or more preconfigured measurement gaps. The measurement gaps manager is further configured to set the activation status as deactivated by the DU of the second network node; and not transmitting the DL MAC CE to activate or deactivate the one or more preconfigured measurement gaps.

Generally, in wireless technologies which include but not limited to NR and LTE, a RRC connected UE performs various measurements for a RRM, positioning of the UE and the like. The UE measures the reference signals which include but not limited to a Synchronization Signal Block (SSB) and a Channel State Information Reference Signal (CSI-RS), and reports to the wireless network For the RRM. The UE reports the SSB/CSI-RS measurements and also reports measurements based on additional reference signals, for example a Positioning Reference Signals (PRS) for positioning. The DL PRS are defined to facilitate support of different positioning methods such as a Downlink Time difference On Arrival (DL-TDOA), a Downlink Angle of Departure (DL-AoD) multi-Multi Round Trip Time (RTT) through the following set of UE measurements Downlink Reference Signal Time Difference (DL RSTD), a Downlink Positioning Reference Signal Received Signal Reference Power (DL PRS-RSRP), and UE Reception Transmission (Rx-Tx) time difference respectively.

In conventional methods and systems, the UE uses measurement gaps that are configured by the network for example gNB in NR,
When the UE needs to measure inter frequency NR or inter-RAT measurements or intra frequency measurements outside the active downlink BWP.
When SSB is not completely contained in the active DL BWP.
When the UE needs to measure PRS.

During the measurement gap period, the UE performs no transmission or reception of data. The Measurement gap configuration which includes but not limited to a gap offset, a gap length, a repetition period and a measurement gap timing advance. The Gap offset specifics the sub-frame where the measurement gap occurs. The Gap length gives the duration of a gap and the repetition period defines how often the measurement gap can occur.

The conventional methods and systems defines a number of measurement gap patterns where each gap pattern corresponds to a gap length and a gap repetition period. For example in NR release 16, discloses 26 gap patterns. A Measurement gap timing advance (MGTA) specifies a timing advance value in MS. The Gap occurs in MGTA milliseconds before the subframe given by the measurement gap offset.

In the conventional methods and systems, the UE is configured with only one measurement gap and the measurement gap, once configured remains activate till it is released.

Further, in the conventional methods and systems, the UE which needs measurement gaps for positioning uses the location measurement indication procedure by sending an RRC Location Measurement Indication message to a serving gNB. The message indicates that the UE is going to start location measurements, or the UE is going to acquire subframe and slot timing of a target E-UTRA system, and includes information required for the gNB to configure the appropriate measurement gaps. UE performs the location measurements or timing acquisition procedures when the gNB has configured the required measurement gaps.

Further, the conventional methods and systems, enhances the measurement gaps by introducing support of multiple gaps and support of the preconfigured gaps. Further the preconfigured gaps are configured by the RRC signaling and can be activated or deactivated dynamically either through the RRC signaling or the L2 MAC signaling or based on some predefined actions. For example a NR Release 17 of 3GPP considers MAC based activation/deactivation of preconfigured gaps for enhanced positioning gaps. Based on the information from a Location Management Function (LMF), gNB configure one or more preconfigured gaps. Each of the preconfigured gaps is associated to a gap id. The LMF can request for the activation or deactivation of pre-configured gaps by sending NRPP messages. The UE also can request the gNB to activate or deactivate the gaps by sending the Medium Access Control Control Element (MAC CE).

Unlike the conventional methods and system, the proposed method deactivates one or more preconfigured measurement gaps without sending Uplink MAC CE.

Unlike the conventional methods and system, the proposed method detects that the one or more preconfigured measurement gaps need to be activated or re-activated after the handover is completed.

Unlike the conventional methods and system, the proposed method activates or re-activates the one or more preconfigured measurement gaps by sending the UL MAC CE.

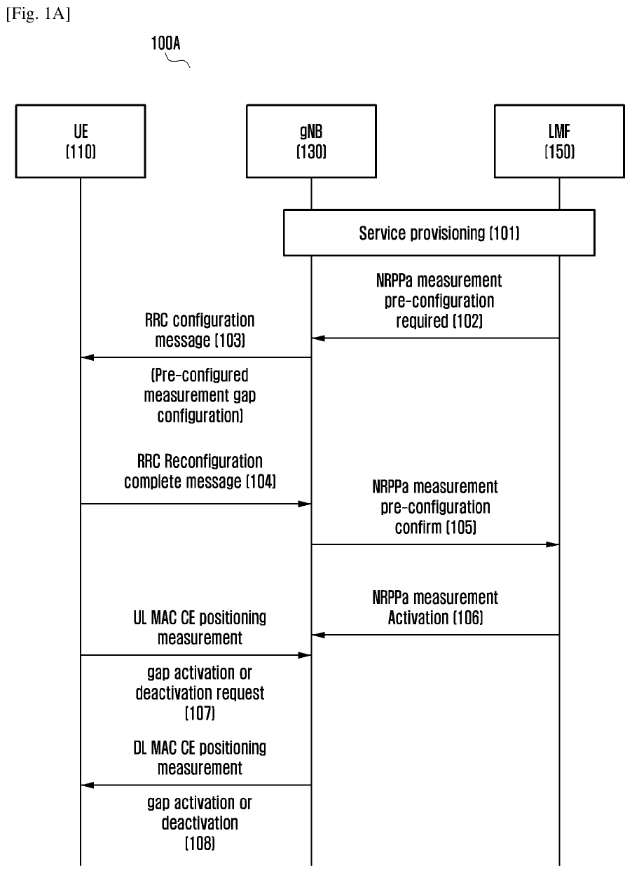

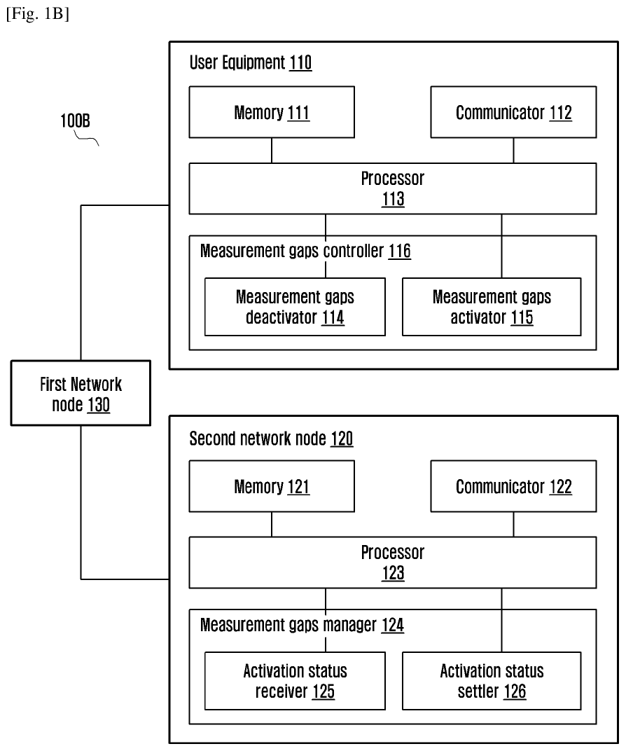

FIG. 1A is a sequence diagram for measurement gaps activation and deactivation for positioning measurement gaps, according to the prior arts.

In conventional methods and systems, the LMF (150) at 101, obtains a Transmission Reception Point (TRP) information required for positioning services from the gNBs.

At 102, the LMF (150) provides the PRS information of the neighbour TRPs to the serving gNB and requests the serving gNB to pre-configure measurement gap via a NRPPa MEASUREMENT PRECONFIGURATION REQUIRED message.

At 103, the serving gNB provides pre-configured measurement gap configuration(s) with associated ID(s) to the UE (110) by sending RRC Reconfiguration message based on an assistance information from the LMF (150) and the UE (110) capability.

At 104, the UE (110) sends RRC Reconfiguration complete message to the gNB to confirm the reception of pre-configured measurement gap configuration.

At 105, the gNB sends the confirmation message to the LMF (150) to indicate the success of the pre-configuration via a NRPPa MEASUREMENT PRECONFIGURATION CONFIRM message.

At 107, the UE (110) sends UL MAC CE Positioning Measurement Gap Activation/Deactivation Request to the gNB and indicates the requested measurement gap configuration based on the ID configured in step 102 when the UE (110) requires measurement gaps for performing the requested location measurements; the triggering condition for UL MAC CE is specified in TS 38.331.

At 106, the LMF (150) send a NRPPa MEASUREMENT ACTIVATION message to request for measurement gap activation.

At 108, the gNB may send DL MAC CE Positioning Measurement Gap Activation/Deactivation containing an ID to activate the associated measurement gap based on the request from the UE (110) in step 107 or the request from the LMF (150) in step 106.

In the conventional method, the UE RRC triggers UE MAC for the activation or deactivation of preconfigured gaps for positioning based on the indication from upper layers to start or stop measurements. An extract of TS 38.331 RRC specification for this is mentioned below.

The UE (110) shall:
1> if and only if upper layers indicate to start performing location measurements towards E-UTRA or NR or start subframe and slot timing detection towards E-UTRA, and the UE (110) requires measurement gaps for these operations while measurement gaps are either not configured or not sufficient:
2> if preconfigured measurement gaps are configured and the UE (110) considers that at least one of the preconfigured gaps meets the measurement gap requirements:
Editor's Note: check if Reference for TS 38.133 on measurement gap requirements is needed.
3> trigger the lower layers to initiate the measurement gap activation request using UL MAC CE as specified in TS 38.321.
2> else:
3> initiate the procedure to indicate start;
NOTE 1: The UE (110) verifies the measurement gap situation only upon receiving the indication from upper layers. If at this point in time sufficient gaps are available, the UE (110) does not initiate the procedure. Unless it receives a new indication from upper layers, the UE (110) is only allowed to further repeat the procedure in the same PCell once per frequency of the target RAT if the provided measurement gaps are insufficient.
1> if and only if upper layers indicate to stop performing location measurements towards E-UTRA or NR or stop subframe and slot timing detection towards E-UTRA and preConfigGapID is not activated:
2> initiate the procedure to indicate stop.
NOTE 2: The UE (110) may initiate the procedure to indicate stop even if it did not previously initiate the procedure to indicate start.
1> if preConfigGapID is activated:
2> if a request from upper layers to transmit either a new preConfigGapID or to modify the current measGapConfig is received; or
2> if a request from upper layers indicate that the current gap is not needed:
3> trigger the lower layers to deactivate the current active measurement gap as specified in TS 38.321.

The UE MAC sends positioning preconfigured gap activation or deactivation request to gNB on the triggers from UE RRC according to below specification. When the UE (110) is configured with the pre-configured measurement gap, the UE (110) may request the network to activate or deactivate the Positioning measurement gap with UL MAC CE for Positioning Measurement Gap Activation/Deactivation Request. The MAC entity shall, when triggered by the upper layer to send Positioning Measurement Gap Activation/Deactivation Request, cancel the triggered Positioning Measurement Gap Activation/Deactivation Request, if any and trigger another Positioning Measurement Gap Activation/Deactivation Request according to the upper layer's request.

The MAC entity shall,
1> if positioning measurement gap activation/deactivation request MAC CE has been triggered, and not cancelled:
2> if UL-SCH resources are available for a new transmission and these UL-SCH resources can accommodate the Positioning Measurement Gap Activation/Deactivation Request MAC CE plus its subheader as a result of logical channel prioritization:
3> instruct the Multiplexing and Assembly procedure to generate the Positioning Measurement Gap Activation/Deactivation Request MAC CE according to the upper layer's request;
3> cancel triggered Positioning Measurement Gap Activation/Deactivation Request MAC CE.
2> else:
3> trigger a Scheduling Request for Positioning Measurement Gap Activation/Deactivation Request MAC CE.

Further the UE MAC handles the preconfigured measurement gap activation command from gNB according to the below extracts from the specification. When the UE (110) is configured with pre-configured measurement gaps, the network may send DL MAC CE for Positioning Measurement Gap Activation/Deactivation Command to the UE. For the activated measurement gap, the UE (110) shall follow the specified UE (110) behavior in the conventional method. Upon the reception of the MAC CE for Positioning Measurement Gap Activation/Deactivation command,

The MAC entity shall:
when the Measurement Gap Activation/Deactivation Command MAC CE indicates the deactivation of a pre-configured positioning measurement gap:
deactivate the positioning measurement gap.
else, when the Positioning Measurement Gap Activation/Deactivation Command MAC CE indicates the activation of a configured measurement gap: activate the positioning measurement gap and perform a standard procedure in the 3GPP.

In NR, cell level mobility for UEs operating in RRC connected mode is performed under network control using handover procedure. Handover can be intra-NR handover or inter-RAT handover. Intra-NR handover can be intra-cell, intra gNB or inter-gNB handover. Intra-gNB handover can be further classified into intra-DU or inter-DU handovers. The UE (110) moves from a source cell to a target cell during a handover. Further in 5G two more types of handover are supported such as—Dual Active Protocol Stack (DAPS) handover and Conditional Handover (CHO).

The DAPS Handover is a handover procedure that maintains the source gNB connection after reception of RRC message for handover and until releasing the source cell after successful random access to the target gNB. During DAPS handover execution period, the UE (110) continues to receive downlink data from both source and target gNBs until the source gNB connection is released by an explicit release command from the target Gnb, while for uplink, the UE (110) transmits UL data to the source gNB until the random access procedure toward the target gNB has been successfully completed. Afterwards the UE (110) switches its UL data transmission to the target gNB.

The CHO is a handover procedure that is executed only when execution condition(s) are met. The UE (110) starts evaluating the execution condition(s) upon receiving a CHO configuration, and stops evaluating the execution condition(s) once a handover is executed.

Referring now to the drawings and more particularly to FIGS. 1B through 8, where similar reference characters denote corresponding features consistently throughout the figures, there are shown preferred embodiments.

FIG. 1B is a block diagram of a system (100B) for handling preconfigured measurement gaps during a handover, according to the embodiments as disclosed herein.

The system includes a User Equipment (UE) (110), a first network node (130) and a second network node (120).

The UE (110) includes a memory (111), a processor (113), a communicator (112) and a measurement gaps controller (116). The measurement gaps controller (116) includes a measurement gaps deactivator (114) and a measurement gaps activator (115). The measurement gaps controller (116) is implemented by processing circuitry such as logic gates, integrated circuits, microprocessors, microcontrollers, memory (111) circuits, passive electronic components, active electronic components, optical components, hardwired circuits, or the like, and may optionally be driven by firmware. The circuits may, for example, be embodied in one or more semiconductors.

The memory (111) is configured to store instructions to be executed by the processor (113). The memory (111) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (111) may, in some examples, be considered a non-transitory storage medium. The term “non-transitory” may indicate that the storage medium is not embodied in a carrier wave or a propagated signal. However, the term “non-transitory” should not be interpreted that the memory (111) is non-movable. In some examples, the memory (111) can be configured to store larger amounts of information. In certain examples, a non-transitory storage medium may store data that can, over time, change (e.g., in Random Access Memory (RAM) or cache).

The processor (113) communicates with the memory (111), the communicator (112) and the measurement gaps controller (116). The processor (113) is configured to execute instructions stored in the memory (111) and to perform various processes. The processor (113) may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (112) includes an electronic circuit specific to a standard that enables wired or wireless communication. The communicator (112) is configured to communicate internally between internal hardware components of the UE (110) and with external devices via one or more networks.

In an embodiment, the measurement gaps controller (116) is configured to perform a handover from the first network node (130) to the second network node (120) in the wireless network. The measurement gaps deactivator (114) deactivates one or more preconfigured measurement gaps without sending Uplink Medium Access Control Control Element (UL MAC CE). The measurement gaps activator (115) detects that the one or more preconfigured measurement gaps need to be activated or re-activated after the handover is completed and activates or reactivates the one or more pre-configured measurement gaps by sending the UL MAC CE.

In an embodiment, the one or more preconfigured measurement gaps is configured during the handover or before the handover.

In an embodiment, the measurement gaps controller (116) is configured to receive a Downlink MAC Control Element (DL MAC CE) to activate or deactivate one or more preconfigured measurement gaps at a UE MAC layer. The measurement gaps controller (116) is further configured to inform a Radio Resource Control (RRC) and other upper layers, the activation or deactivation status of the one or more pre-configured measurement gaps by the UE MAC layer.

In an embodiment, the measurement gaps controller (116) is configured to determine whether the one or more preconfigured measurement gaps is modified during the handover. The measurement gaps controller (116) is further configured to determine whether the UE (110) is required to stop performing measurements using the one or more pre-configured measurement gaps. The measurement gaps controller (116) is further configured to send the UL MAC CE to the second network node (120) to reactivate the one or more preconfigured measurement gaps that was previously active before the handover when the one or more preconfigured measurement gaps is not modified and the UE (110) is not required to stop performing measurements using the one or more pre-configured measurement gaps. The measurement gaps controller (116) is further configured to send the UL MAC CE to the second network node (120) to activate at least one of a one or more new measurement gaps and modify the one or more preconfigured measurement gaps when the one or more pre-configured measurement gaps is modified and the UE (110) is not required to stop performing measurements using the one or more pre-configured measurement gaps.

In an embodiment, the measurement gaps controller (116) is configured to receive a RRC reconfiguration message from the first network node (130). The measurement gaps controller (116) is further configured to determine whether the RRC reconfiguration message comprises at least one of a gap activation status and reset gap activation status indication and a keep gap activation status indication. The measurement gaps controller (116) is further configured to deactivate all preconfigured measurement gaps when the RRC reconfiguration message comprises the reset gap activation status indication. The measurement gaps controller (116) is further configured to keep the activated preconfigured measurement gaps remains active and deactivated pre-configured measurement gaps remain deactivated when the RRC reconfiguration message comprises the keep gap activation status indication or when the UE (110) does not receives the gap activation status from the first network node (130).

In an embodiment, the measurement gaps controller (116) is configured to receive the RRC reconfiguration message from the first network node (130) including a second network node (120) RRC Reconfiguration message containing a ReconfigurationwithSync that is received from the second network node (120); and executing a ReconfigurationwithSync procedure for handover. The measurement gaps controller (116) is further configured to receive a conditional reconfiguration message from the first network node (130); determining whether the conditions in the conditional reconfiguration message are fulfilled. The measurement gaps controller (116) is further configured to execute a ReconfigurationwithSync procedure for handover when the conditions for the execution in the conditional reconfiguration message are fulfilled.

The second network node (120) includes a memory (121), a processor (123), a communicator (122) and a measurement gaps manager (124). The measurement gaps manager (124) includes an activation status receiver (125) and an activation status settler (126). The measurement gaps manager (124) is implemented by processing circuitry such as logic gates, integrated circuits, microprocessors, microcontrollers, memory (121) circuits, passive electronic components, active electronic components, optical components, hardwired circuits, or the like, and may optionally be driven by firmware. The circuits may, for example, be embodied in one or more semiconductors.

The memory (121) is configured to store instructions to be executed by the processor (123). The memory (121) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (121) may, in some examples, be considered a non-transitory storage medium. The term “non-transitory” may indicate that the storage medium is not embodied in a carrier wave or a propagated signal. However, the term “non-transitory” should not be interpreted that the memory (121) is non-movable. In some examples, the memory (121) can be configured to store larger amounts of information. In certain examples, a non-transitory storage medium may store data that can, over time, change (e.g., in Random Access Memory (RAM) or cache).

The processor (123) communicates with the memory (121), the communicator (122) and the measurement gaps manager (124). The processor (123) is configured to execute instructions stored in the memory (121) and to perform various processes. The processor (123) may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (122) includes an electronic circuit specific to a standard that enables wired or wireless communication. The communicator (122) is configured to communicate internally between internal hardware components of the second network node (120) and with external devices via one or more networks.

The activation status receiver (125) receives an activation status of one or more preconfigured measurement gaps from the first network node (130) in a handover request message. The measurement gaps manager (124) is configured to transmit the activation status of the one or more preconfigured measurement gaps from a CU of the second network node (120) to a DU of the second network node (120). Wherein gNB may consist of the CU and the DU. RRC related functionalities reside in the CU while a RLC, a MAC and other lower layers are handled by the DU. The activation status settler (126) sets the activation status by the DU of the second network node (120) of the one or more preconfigured measurement gaps based on the received activation status from the CU of the second network node (120); and transmits the DL MAC CE to activate or deactivate the one or more preconfigured measurement gaps. The activation status settler (126) set the activation status as deactivated by the DU of the second network node (120); and not transmits the DL MAC CE to activate or deactivate the one or more preconfigured measurement gaps. NR protocol stack includes but not limited to different layers like layer 1, layer 2 that includes the MAC and other layers, layer 3 that includes the RRC and the like.

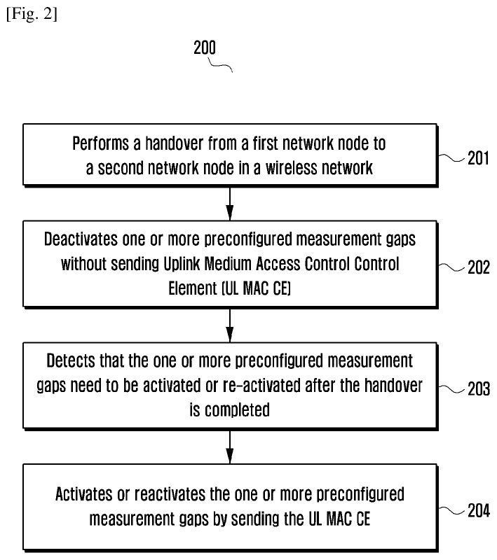

FIG. 2 is a flow chart (200) illustrating a method for handling the preconfigured measurement gaps during the handover by the UE, according to the embodiments as disclosed herein.

At step 201, the UE (110) performs the handover from the first network node (130) to the second network node (120) in the wireless network.

At step 202, the UE (110) deactivates the one or more preconfigured measurement gaps without sending the UL MAC CE.

At step 203, the UE (110) detects that the one or more preconfigured measurement gaps need to be activated or re-activated after the handover is completed.

At step 204, the UE (110) activates or reactivates the one or more preconfigured measurement gaps by sending the UL MAC CE

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention

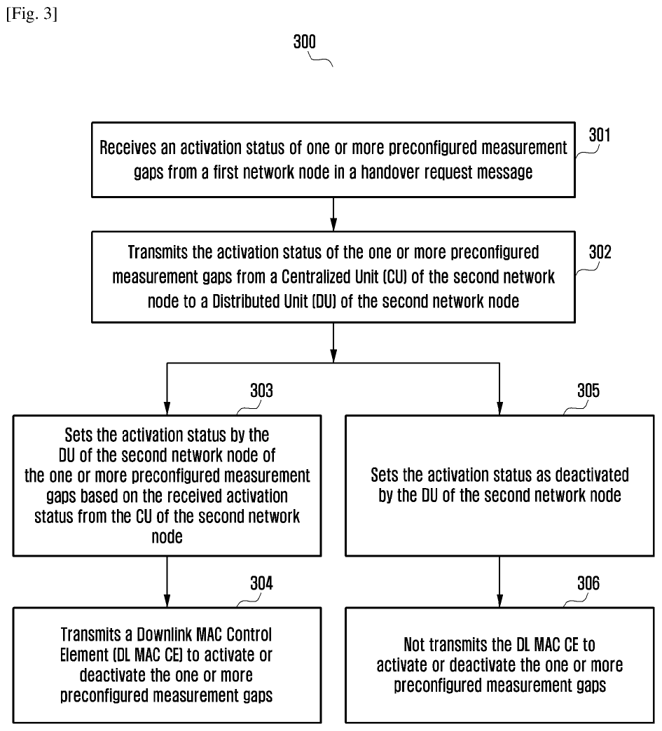

FIG. 3 is a flow chart (300) illustrating a method for handling the preconfigured measurement gaps during the handover by a second network node (120), according to the embodiments as disclosed herein.

At step 301, the second network node (120) receives the activation status of the one or more preconfigured measurement gaps from the first network node (130) in the handover request message.

At step 302, the second network node (120) transmits the activation status of the one or more preconfigured measurement gaps from the CU of the second network node (120) to the DU of the second network node (120).

At step 303, the second network node (120) sets the activation status by the DU of the second network node (120) of the one or more preconfigured measurement gaps based on the received activation status from the CU of the second network node (120).

At step 304, the second network node (120) transmits the DL MAC CE to activate or deactivate the one or more preconfigured measurement gaps.

At step 305, the second network node (120) sets the activation status as deactivated by the DU of the second network node (120).

At step 306, the second network node (120) not transmits the DL MAC CE to activate or deactivate the one or more preconfigured measurement gaps.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention

FIG. 4 illustrating a whole scenario of handling of the preconfigured measurement gaps during the handover, according to the embodiments as disclosed herein.

At step 401, the UE (110) Starts execution of Handover or Radio Resource Control (RRC) ReconfigurationWithSync.

At step 402, the UE (110) deactivates all the activated preconfigured measurement gaps without sending the UL MAC CE.

At step 403, the UE (110) completes handover with successful random access on target cell.

At step 404, the UE (110) determines whether preconfigured measurement gaps is modified or need to stop measurements.

At step 405, the UE (110) Sends UL MAC CE to activate the preconfigured measurement gaps which were activated before handover.

At step 406, the UE (110) determines whether any need to stop measurements.

At step 407, the UE (110) performs no action as the gap is already deactivated when any need to stop measurements.

At step 408, the UE (110) sends UL MAC CE to activate the new gap or send location measurement indication to request for modified gap when no need to stop measurements.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

In an embodiment, the UE (110) and the gNB deactivate any of the activated pre-configured measurement gaps upon a handover such that the activation status of all the preconfigured gaps upon handover is deactivated. Further the deactivation of pre-configured gaps is performed by MAC layer at UE (110) and gNB. In an embodiment the RRC layer or upper layers like LTE Positioning Protocol (LPP) initiates the request to MAC to deactivate the gap, wherein Layers like LPP is considered as upper layers for the RRC.

In an embodiment, deactivation of the pre-configured gaps upon a handover, is performed implicitly without any exchange of signaling like UL MAC CE between the UE (110) and the gNB. For example the UE (110) does not send positioning measurement gap Activation/Deactivation request MAC CE for the positioning measurement gap. The deactivation of preconfigured gaps may be performed irrespective of the type of handover-intra-gNB/inter-gNB or conditional handover or DAPS handover and irrespective of whether MAC is reset during the handover.

In an embodiment, the UE (110) may deactivate the preconfigured measurement gaps before random access is performed in the target cell.

In an embodiment, the UE (110) deactivates preconfigured measurement gap while executing ReconfigurationWithSync. In conventional method, the ReconfigurationWithSync is executed, upon reception of the RRCReconfiguration, or upon execution of the CHO when the RRCReconfiguration being processed contain masterCellGroup secondaryCellgroup and CellGroupConfig contains the spCellConfig with the reconfigurationWithSync.

In an embodiment, the UE (110) deactivate the preconfigured gaps in both source cell and target cell while executing ReconfigurationWithSync while executing DAPS handover. For the CHO or conditional Primary Serving cell (PSCell) change, UE (110) keeps any activated preconfigured measurement gap as activated in source cell till the handover execution is completed but deactivates all the preconfigured gaps in all the target cells.

In an embodiment, the gNB may deactivate any activated preconfigured gap in both source cell and target cell during transmission of the RRCReconfiguration while executing the DAPS handover. For the CHO or the conditional PSCell Change, the gNB keeps any activated preconfigured measurement gap as activated in source cell till the handover execution is completed, but deactivates all the preconfigured gaps in all the target cells.

In an embodiments update in the NR MAC related conventional systems and the Positioning Measurement Gap Activation/Deactivation Request is: when the UE (110) is configured with the pre-configured measurement gap, the UE (110) may request the network to activate or deactivate the Positioning measurement gap with UL MAC CE for Positioning Measurement Gap Activation/Deactivation Request. The configured preconfigured measurement gaps are deactivated upon the handover before random access is performed in the target without sending the UL MAC CE for positioning Measurement Gap Activation/Deactivation Request.

In an embodiments, update in the NR RRC specification with Reconfiguration with sync is mentioned below:

The UE (110) shall perform the following actions to execute the reconfiguration with sync.
1> if the AS security is not activated, perform the actions upon going to RRC_IDLE with the release cause ‘other’ upon which the procedure ends;
1> if no DAPS bearer is configured:
2> stop timer T310 for the corresponding SpCell, if running;
1> if this procedure is executed for the MCG:
2> if timer T316 is running;
3> stop timer T316;
3> clear the information included in VarRLF-Report, if any;
2> resume MCG transmission, if suspended.
1> stop timer T312 for the corresponding SpCell, if running;
1> start timer T304 for the corresponding SpCell with the timer value set to t304, as included in the reconfigurationWithSync;
1> if the frequencyInfoDL is included:
2> consider the target SpCell to be one on the SSB frequency indicated by the frequencyInfoDL with a physical cell identity indicated by the physCellId;
1> else:
2> consider the target SpCell to be one on the SSB frequency of the source SpCell with a physical cell identity indicated by the physCellId;
1> start synchronising to the DL of the target SpCell;
1> apply the specified BCCH configuration for the target SpCell;
1> acquire the MIB of the target SpCell, which is scheduled as specified in TS 38.213;
NOTE 1: The UE (110) should perform the reconfiguration with sync as soon as possible following the reception of the RRC message triggering the reconfiguration with sync, which could be before confirming successful reception (HARQ and ARQ) of this message.
NOTE 2: The UE (110) may omit reading the MIB if the UE (110) already has the required timing information, or the timing information is not needed for random access.
NOTE 2a: The UE (110) with DAPS bearer does not monitor for system information updates in the source PCell.
1> If any DAPS bearer is configured:
2> create a MAC entity for the target cell group with the same configuration as the MAC entity for the source cell group;
2> consider the preconfigured measurement gaps, if activated by MAC CE for positioning measurement, to be deactivated state in both source cell group and target cell group and inform upper layers about the gap deactivation;
2> for each DAPS bearer:
3> establish an RLC entity or entities for the target cell group, with the same configurations as for the source cell group;
3> establish the logical channel for the target cell group, with the same configurations as for the source cell group;
NOTE 2b: In order to understand if a DAPS bearer is configured, the UE (110) needs to check the presence of the field daps-Config within the RadioBearerConfig IE received in radioBearerConfig or radioBearerConfig2.
2> for each SRB:
3> establish an RLC entity for the target cell group, with the same configurations as for the source cell group;
3> establish the logical channel for the target cell group, with the same configurations as for the source cell group;
2> suspend SRBs for the source cell group;
NOTE 3: Void
2> apply the value of the newUE-Identity as the C-RNTI in the target cell group;
2> configure lower layers for the target SpCell in accordance with the received spCellConfigCommon;
2> configure lower layers for the target SpCell in accordance with any additional fields, not covered in the previous, if included in the received reconfigurationWithSync.
1> else:
2> reset the MAC entity of this cell group;
2> consider the preconfigured measurement gaps, if activated by MAC CE for positioning measurement, to be deactivated state and inform upper layers about the gap deactivation;
2> consider the SCell(s) of this cell group, if configured, that are not included in the SCellToAddModList in the RRCReconfiguration message, to be in deactivated state;
2> apply the value of the newUE-Identity as the C-RNTI for this cell group;
2> configure lower layers in accordance with the received spCellConfigCommon;
2> configure lower layers in accordance with any additional fields, not covered in the previous, if included in the received reconfigurationWithSync.

In an embodiment, the UE (110) sends a request including the UL MAC CE like Positioning Measurement Gap Activation/Deactivation Request to activate the pre-configured measurement gaps which were previously activated in the source cell at the time of handover and were deactivated in the previous step. The request sent when the measurement gap configuration has not changed upon handover and there is no need to stop the measurements.

In an embodiment, the UE (110) checks when the configuration of the preconfigured measurement gaps has changed at the handover and sends the request to activate the preconfigured measurement gaps which were active in the source cell at the time of the handover, only when the configuration of preconfigured measurement gaps have not changed.

In an embodiment, the UE (110) request for activating the preconfigured measurement gap as per the above embodiment be triggered by the UE MAC itself. Alternatively, the request can be triggered by the UE RRC to the UE MAC and then UE MAC sends the UL MAC CE to activate the required preconfigured measurement gap.

In an embodiment, the UE RRC not triggers UE MAC to send the request to activate the preconfigured measurement gaps which were active at the time of the handover in source cell, when upper layers indicate to stop measurements. For e.g. when the pre-configured measurement gaps are positioning measurement gaps, when LPP layer indicates to stop measurements, UE RRC not triggers UE MAC for the request to activate the gaps. The flow is mentioned below:

The UE (110) shall:
1> if and only if upper layers indicate to start performing location measurements towards E-UTRA or NR or start subframe and slot timing detection towards E-UTRA, and the UE (110) requires measurement gaps for these operations while measurement gaps are either not configured or not sufficient.
2> if preconfigured measurement gaps are configured and the UE (110) considers that at least one of the preconfigured gaps meets the measurement gap requirements:
Note: check if reference for TS 38.133 on measurement gap requirements is needed.
3> trigger the lower layers to initiate the measurement gap activation request using UL MAC CE;
2> else:
3> initiate the procedure to indicate start;
NOTE 1: The UE (110) verifies the measurement gap situation only upon receiving the indication from upper layers. If at this point in time sufficient gaps are available, the UE (110) does not initiate the procedure. Unless it receives a new indication from upper layers, the UE (110) is only allowed to further repeat the procedure in the same PCell once per frequency of the target RAT if the provided measurement gaps are insufficient.
1> if and only if upper layers indicate to stop performing location measurements towards E-UTRA or NR or stop subframe and slot timing detection towards E-UTRA and preConfigGapID is not activated:
2> initiate the procedure to indicate stop.
NOTE 2: The UE (110) may initiate the procedure to indicate stop even if it did not previously initiate the procedure to indicate start.
1> if preConfigGapID is activated:
2> if a request from upper layers to transmit either a new preConfigGapID or to modify the current measGapConfig is received; or
2> if a request from upper layers indicate that the current gap is not needed:
3> trigger the lower layers to deactivate the current active measurement gap;
2> If upon a handover, if the current measGapConfig is not modified and there is no request from upper layers to stop performing location measurements towards E-UTRA or NR or stop subframe and slot timing detection towards E-UTRA
3> trigger the lower layers to initiate the measurement gap activation request for previously activated gap using UL MAC CE.

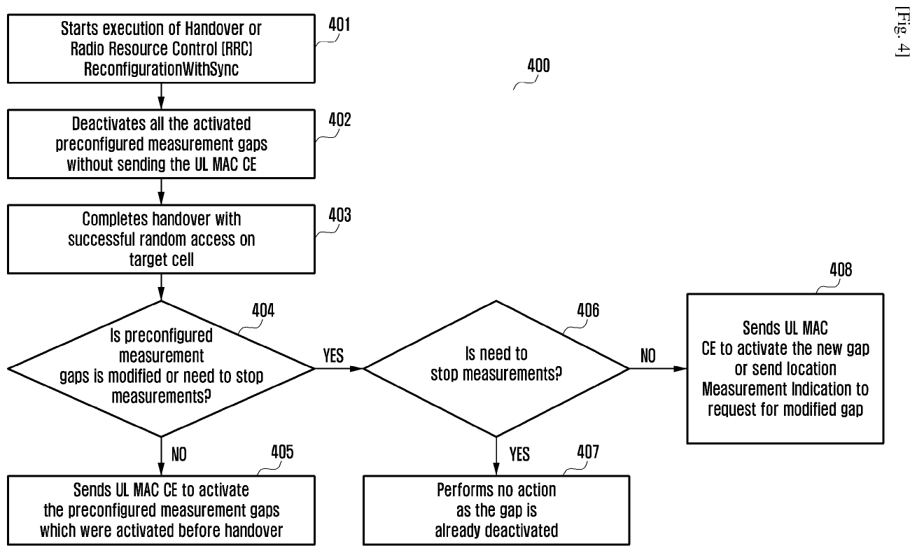

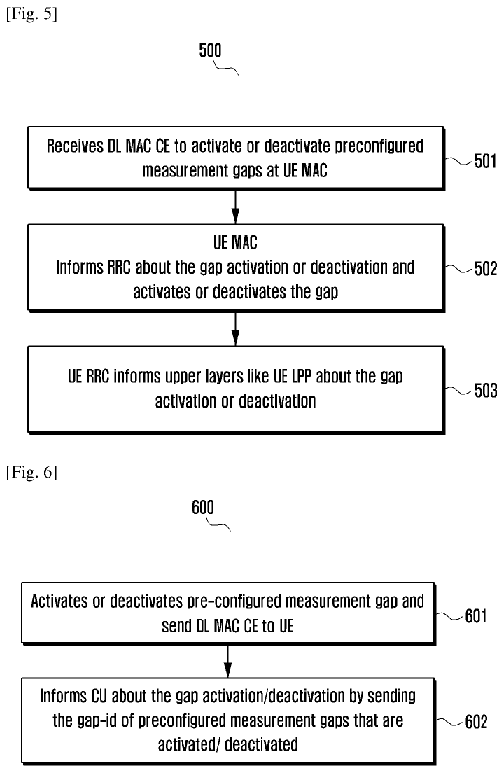

FIG. 5 illustrating a scenario of handling the DL MAC CE by the UE (110) to activate or deactivate the preconfigured measurement gaps, according to the embodiments as disclosed herein.

At step 501, the UE (110) receives the DL MAC CE to activate or deactivate pre-configured measurement gaps at UE MAC.

At step 502, the UE MAC Informs RRC about the gap activation or deactivation and activates or deactivates the gap.

At step 503, the UE RRC informs upper layers like UE LPP about the gap activation or deactivation.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

In an embodiment, the UE RRC informs LPP layer that a handover has occurred or that the gaps are deactivated upon handover. Further the LPP layers requests the RRC layer to trigger MAC layer to initiate measurement gap activation request using UL MAC CE.

In an embodiment, when the measurement gap configuration is modified, the UE (110) RRC performs one or both of the actions. RRC trigger the lower layers to initiate the activation of preconfigured measurement gap when the modified pre-MG configuration is enough for the ongoing measurements and/or RRC informs upper layer that is i.e., LPP of the modification of pre-MG which implies that the previous activated pre-MG is not valid anymore. LPP layer requests RRC to start the measurements or trigger lower layers to initiate activation of any preconfigured measurement gap.

In an embodiment, the UE MAC informs the UE RRC on receiving the command for activation/deactivation of the preconfigured gap, for example positioning measurement gap activation/deactivation command, irrespective of whether the previous request for activation/deactivation is triggered by UE RRC. For example, in the case of pre-configured gaps for positioning, even when the Positioning Measurement Gap Activation/Deactivation Command is received due to a request from LMF, UE RRC be informed. UE RRC also informs upper layers like UE LPP about gap activation or deactivation, that help the UE RRC and UE LPP to handle the concurrency with LMF initiated gap activation and gap deactivation, for e.g. to prevent duplicated pre-MG activation/deactivation procedures-one initiated by UE (110) and other initiated by LMF.

The UE (110) shall:
1> if and only if upper layers indicate to start performing location measurements towards E-UTRA or NR or start subframe and slot timing detection towards E-UTRA, and the UE (110) requires measurement gaps for these operations while measurement gaps are either not configured or not sufficient:
2> if preconfigured measurement gaps are configured and the UE (110) considers that at least one of the preconfigured gaps meets the measurement gap requirements:
3> trigger the lower layers to initiate the measurement gap activation request using UL MAC CE;
2> else:
3> initiate the procedure to indicate start;
NOTE 1: The UE (110) verifies the measurement gap situation only upon receiving the indication from upper layers. If at this point in time sufficient gaps are available, the UE (110) does not initiate the procedure. Unless it receives a new indication from upper layers, the UE (110) is only allowed to further repeat the procedure in the same PCell once per frequency of the target RAT if the provided measurement gaps are insufficient.
1> if and only if upper layers indicate to stop performing location measurements towards E-UTRA or NR or stop subframe and slot timing detection towards E-UTRA and preConfigGapID is not activated:
2> initiate the procedure to indicate stop.
NOTE 2: The UE (110) may initiate the procedure to indicate stop even if it did not previously initiate the procedure to indicate start.
1> if preConfigGapID is activated:
2> if a request from upper layers to transmit either a new preConfigGapID or to modify the current measGapConfig is received; or
2> if a request from upper layers indicate that the current gap is not needed:
3> trigger the lower layers to deactivate the current active measurement gap.
Note: UE RRC informs activation status of preconfigured gaps to upper layers upon receiving information from lower layers about the activation or deactivation of pre-configured measurement gaps.

In an embodiment, the positioning measurement gap activation/deactivation command is mentioned below: when the UE (110) is configured with pre-configured measurement gaps, the network may send DL MAC CE for Positioning Measurement Gap Activation/Deactivation Command to the UE. For the activated measurement gap, the UE (110) shall follow the specified UE (110) behavior. Upon the reception of the MAC CE for Positioning Measurement Gap Activation/Deactivation command, the MAC entity shall:
when the Measurement Gap Activation/Deactivation Command MAC CE indicates the deactivation of a pre-configured positioning measurement gap:
Deactivate the positioning measurement gap and inform upper layers.
else if the Positioning Measurement Gap Activation/Deactivation Command MAC CE indicates the activation of a configured measurement gap:
Activate the positioning measurement gap and perform the procedure specified in conventional standards and inform upper layers.

FIG. 6 illustrating a scenario of handling the DL MAC CE by the second network node (120), according to the embodiments as disclosed herein.

At step 601, the DU of the second network node (120) activates or deactivates pre-configured measurement gap and sends the DL MAC CE to the UE.

At step 602, the DU of the second network node (120) informs the CU about the gap activation/deactivation by sending the gap-id of preconfigured measurement gaps that are activated/deactivated.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention

In an embodiment, the DU of the gNB informs the CU of the gNB about the gap activation status for each of the preconfigured measurement gap. When a preconfigured measurement gap is activated or deactivated, DU informs CU the gap-identifier(s) of the preconfigured measurement gap that is activated or deactivated. The CU sends the required gap activation status of the preconfigured gap that is the gap id(s) of the gaps to be activated or deactivated to target DU during the intra-CU handover.

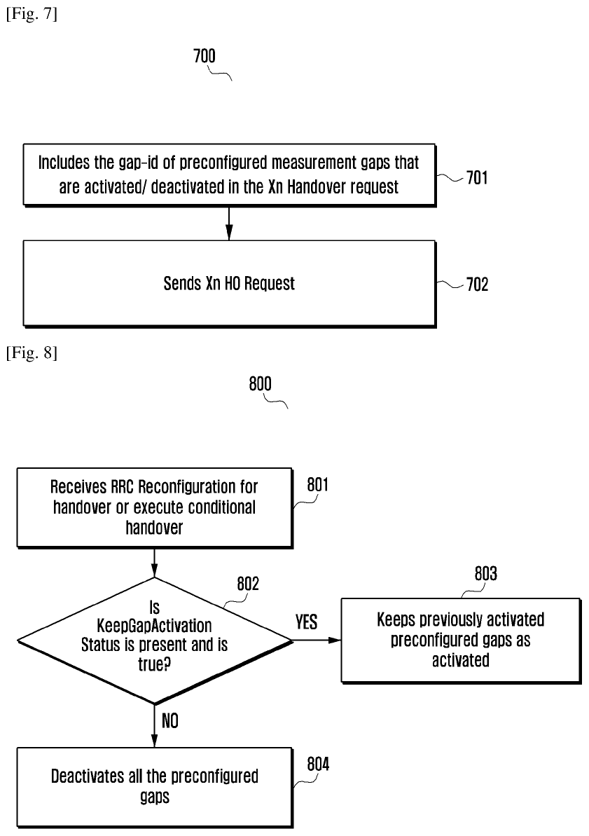

FIG. 7 illustrating a scenario of handling the preconfigured measurement gaps by the first network node (130), according to the embodiments as disclosed herein.

At step 701, the first network node (130) includes the gap-id of the preconfigured measurement gaps that are activated/deactivated in the Xn Handover request.

At step 702, the first network node (130) sends the Xn HO request.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention

In an embodiment, during the inter-gNB handover, the source gNB sends the gap activation status for each to the preconfigured measurement gaps to the target gNB. The Source gNB may indicate the gap-ids for the list of gaps that are either activated or de-activated to the target gNB in the Xn message or in a NG Application Protocol (NGAP) message when the inter-gNB handover is routed through AMF, wherein the NGAP is an Application protocol between gNB and the Access and Mobility Management Function (AMF). The target gNB CU sends the required gap activation status of the preconfigured gap with the gap id of the gaps to be activated or de-activated, to the target DU during the handover

FIG. 8 illustrating a scenario of determining gap activation status in the RRC message, according to the embodiments as disclosed herein.

At step 801, the UE (110) receives the RRC Reconfiguration for handover or request for CHO.

At step 802, the UE (110) determines whether the KeepGapActivation Status is present.

At step 803, the UE (110) keeps previously activated preconfigured gaps as activated when the KeepGapActivation Status is present.

At step 804, the UE (110) deactivates all the preconfigured gaps when the KeepGapActivation Status is not present.

In an embodiment, the gNB indicates to the UE (110) whether to keep the current gap status or whether to deactivate the gap in the RRC Reconfiguration message, during the handover. This embodiment is also applied when the UE (110) executes conditional handover.

In an embodiment, the UE (110) either deactivates or activates the preconfigured measurement gap or keep the current gap status according to the received IE in the RRC Reconfiguration message.

In an embodiment, the gNB sends the indication to reset the gap activation status for all the preconfigured measurement gaps to the UE. For example Information Element (IE) is ResetGapActivationStatus—when the IE is send by gNB, UE (110) deactivates all the preconfigured measurement gaps. Otherwise UE (110) keeps the current gapActivation status for all preconfigured gaps that is gaps activated remains activated and gaps deactivated remain deactivated.

In an embodiment, the gNB sends the indication to keep the gap activation status for all the preconfigured measurement gaps to the UE. For example KeepGapActivationStatus: If this IE is send by gNB, UE (110) keeps the current gap status during reconfiguration for all the preconfigured gaps that is gaps activated remains activated and gaps deactivated remains deactivated. Otherwise UE (110) deactivates all the pre-configured gaps.

In an embodiment, the gNB sends gap activation status whether activated or de-activated individually for each preconfigured measurement gap to the UE. When the gap activation status is not send, the UE (110) keeps the current gap activation status that is gaps activated remains activated and gaps deactivated remains deactivated.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within scope of the embodiments as described herein.

1. A method performed by a user equipment (UE) for handling preconfigured measurement gaps during handover in a wireless network, comprising:
performing a handover from a first network node to a second network node in the wireless network;
deactivating one or more preconfigured measurement gaps;
detecting that the one or more preconfigured measurement gaps need to be activated after the handover is completed; and
activating the one or more preconfigured measurement gaps by transmitting uplink medium access control control element (UL MAC CE).

2. The method of claim 1, wherein the one or more preconfigured measurement gaps is configured during the handover.

3. The method of claim 1, further comprising:
receiving a Downlink MAC Control Element (DL MAC CE) to activate or deactivate one or more preconfigured measurement gaps at a UE MAC layer; and
informing, by the UE MAC layer, a Radio Resource Control (RRC) layer or other upper layers, an activation or deactivation status of the one or more preconfigured measurement gaps.

4. The method of claim 1, further comprising:
determining whether the one or more preconfigured measurement gaps is modified during the handover;
determining whether the UE is required to stop performing measurements using the one or more pre-configured measurement gaps;
performing one of:
transmitting, to the second network node, the UL MAC CE to re-activate the one or more preconfigured measurement gaps that was previously active before the handover in case that the one or more preconfigured measurement gaps is not modified and the UE is not required to stop performing measurements using the one or more pre-configured measurement gaps; or
transmitting, to the second network node, the UL MAC CE to activate at least one of a one or more new measurement gaps and modify the one or more preconfigured measurement gaps in case that the one or more pre-configured measurement gaps is modified and the UE is not required to stop performing measurements using the one or more pre-configured measurement gaps.

5. The method of claim 1, wherein deactivating the one or more pre-configured measurement gaps that is configured at least one of during the handover or before the handover, comprising:
receiving, from the first network node, a RRC Reconfiguration message;
determining whether the RRC reconfiguration message comprises at least one of a gap activation status, reset gap activation status indication or a keep gap activation status indication;
performing one of:
deactivating all preconfigured measurement gaps in case that the RRC reconfiguration message comprises the reset gap activation status indication; or
keeping the activated preconfigured measurement gaps remains active and deactivated preconfigured measurement gaps remain deactivated in case that the RRC reconfiguration message comprises the keep gap activation status indication or in case that the UE does not receives the gap activation status from the first network node.

6. The method of claim 1, wherein performing the handover from the first network node to the second network node, comprising:
performing one of:
receiving, from the first network node, the RRC reconfiguration message including a second network node RRC Reconfiguration message containing a ReconfigurationwithSync that is received from the second network node; and executing a ReconfigurationwithSync procedure for handover; or
receiving, from the first network node, a conditional reconfiguration message; determining whether the conditions in the conditional reconfiguration message are fulfilled; and a ReconfigurationwithSync procedure for handover in case that the conditions for the execution in the conditional reconfiguration message are fulfilled.

7. A method performed by a second network node for handling preconfigured measurement gaps during handover in a wireless network, comprising:
receiving, from a first network node in a handover request message, an activation status of one or more preconfigured measurement gaps;
transmitting, from a centralized unit (CU) of the second network node to a distributed unit (DU) of the second network node, the activation status of the one or more preconfigured measurement gaps;
performing at least one of:
setting, by the DU of the second network node, the activation status of the one or more preconfigured measurement gaps based on the received activation status from the CU of the second network node; and transmitting a Downlink MAC Control Element (DL MAC CE) to activate or deactivate the one or more preconfigured measurement gaps; or
setting, by the DU of the second network node, the activation status as deactivated; and not transmitting the DL MAC CE to activate or deactivate the one or more preconfigured measurement gaps.

8. An User Equipment (UE) for handling preconfigured measurement gaps during handover in a wireless network, the UE comprising:
a memory;
a processor coupled to the memory; and
a measurement gaps controller coupled to the memory and the processor, and configured to:
perform a handover from a first network node to a second network node in the wireless network;
deactivate one or more preconfigured measurement gaps;
detect that the one or more preconfigured measurement gaps need to be activated after the handover is completed; and
activate the one or more preconfigured measurement gaps by transmitting uplink medium access control control element (UL MAC CE).

9. The UE of claim 8, wherein the one or more preconfigured measurement gaps is configured during the handover.

10. The UE of claim 8, wherein the measurement gaps controller is configured to:
receive a Downlink MAC Control Element (DL MAC CE) to activate or deactivate one or more preconfigured measurement gaps at a UE MAC layer; and
inform, by the UE MAC layer, a Radio Resource Control (RRC) layer or other upper layers, an activation or deactivation status of the one or more preconfigured measurement gaps.

11. The UE of claim 8, wherein the measurement gaps controller is configured to:
determine whether the one or more preconfigured measurement gaps is modified during the handover;
determine whether the UE is required to stop performing measurements using the one or more pre-configured measurement gaps;
perform one of:
transmit, to the second network node, the UL MAC CE to re-activate the one or more preconfigured measurement gaps that was previously active before the handover in case that the one or more preconfigured measurement gaps is not modified and the UE is not required to stop performing measurements using the one or more pre-configured measurement gaps; and
transmit, to the second network node, the UL MAC CE to activate at least one of a one or more new measurement gaps and modify the one or more preconfigured measurement gaps in case that the one or more pre-configured measurement gaps is modified and the UE is not required to stop performing measurements using the one or more pre-configured measurement gaps.

12. The UE of claim 8, wherein deactivating the one or more pre-configured measurement gaps that is configured at least one of during the handover or before the handover, comprises:
receive, from the first network node, a RRC reconfiguration message;
determine whether the RRC reconfiguration message comprises at least one of a gap activation status, reset gap activation status indication or a keep gap activation status indication;
perform one of:
deactivate all preconfigured measurement gaps in case that the RRC reconfiguration message comprises the reset gap activation status indication; or
keep the activated preconfigured measurement gaps remains active and deactivated preconfigured measurement gaps remain deactivated in case that the RRC reconfiguration message comprises the keep gap activation status indication or in case that the UE does not receives the gap activation status from the first network node.

13. The UE of claim 8, wherein performing the handover from the first network node to the second network node, comprises:
perform one of:
receive, from the first network node, the RRC reconfiguration message including a second network node RRC Reconfiguration message containing a ReconfigurationwithSync that is received from the second network node; and execute a ReconfigurationwithSync procedure for handover; or
receive, from the first network node, a conditional reconfiguration message; determining whether the conditions in the conditional reconfiguration message are fulfilled; and execute a ReconfigurationwithSync procedure for handover in case that the conditions for the execution in the conditional reconfiguration message are fulfilled.

14. A second network node for handling preconfigured measurement gaps during handover in a wireless network, comprises:
a memory;
a processor coupled to the memory; and
a measurement gaps manager coupled to the memory and the processor, and configured to:
receive, from a first network node in a handover request message, an activation status of one or more preconfigured measurement gaps;
transmit, from a centralized unit (CU) of the second network node to a distributed unit (DU) of the second network node, the activation status of the one or more preconfigured measurement gaps; and
perform at least one of:
set, by the DU of the second network node, the activation status of the one or more preconfigured measurement gaps based on the received activation status from the CU of the second network node; and transmits a Downlink MAC Control Element (DL MAC CE) to activate or deactivate the one or more preconfigured measurement gaps; or
set, by the DU of the second network node, the activation status as deactivated; and not transmits the DL MAC CE to activate or deactivate the one or more preconfigured measurement gaps.
